(19) United States
(12) Patent Application Publication
(10) Pub. No.: US 2012/0044209 A1
(43) Pub. Date: Feb. 23, 2012

(54) TOUCH SCREEN PANEL

(76) Inventor: Sang-Uk Kim, Yongin-city (KR)

(21) Appl. No.: 13/004,680

(22) Filed: Jan. 11, 2011

(30) Foreign Application Priority Data
Aug. 19, 2010 (KR) 10-2010-0080273

(51) Int. Cl. G06F 3/042

(52) U.S. Cl. 345/175

(57) ABSTRACT

A touch screen panel includes: a touch input region; infrared ray emitters at first and second sides of the touch input region for emitting infrared rays toward infrared ray sensors disposed at third and fourth sides, respectively, of the touch input region, each of the infrared ray emitters including: a light guide plate having a light emitting surface on a side of the light guide plate facing the touch input region, V-shaped oblique grooves at an angle on another side of the light guide plate facing the light emitting surface, and a light incident surface; an infrared ray light source facing the light incident surface of the light guide plate; and a reverse prism seat between the touch input region and the light guide plate and having a light incident surface at a side facing the light guide plate and polygonal reverse prism threads on the light incident surface.

### CROSS-REFERENCE TO RELATED APPLICATION

This application claims priority to and the benefit of Korean Patent Application No. 10-2010-0080273, filed on Aug. 19, 2010, in the Korean Intellectual Property Office, the entire content of which is incorporated herein by reference.

### BACKGROUND

1. Field

Embodiments of the present invention relate to a touch screen panel, and particularly to an infrared touch screen panel.

2. Description of the Related Art

A touch screen panel is an input device enabling a person to select an instruction displayed on a screen of an image display device with his/her finger or a tool and to input a user command.

To this end, the touch screen panel is provided in a front face of the image display device and converts a contact position on the screen with which a finger or a tool contacts (e.g., directly contacts) into an electrical signal. By doing so, an instruction selected at the contact position is input as an input signal.

Generally, touch screen panels tend to increase a range of applications because the touch screen panel can be a substitute for separate input devices such as a keyboard and a mouse that are coupled to an image display device.

There are various known touch screen panels such as a resistive touch screen panel, a capacitive touch screen panel, and an infrared touch screen panel.

Generally, an infrared touch screen panel uses properties of an infrared ray having directionality that is blocked by an obstacle and that does not advance.

### SUMMARY

Accordingly, aspects of embodiments of the present invention are directed to an infrared touch screen panel having improved emission property of infrared ray.

In order to achieve the foregoing and/or other aspects of the present invention, according to an embodiment of the present invention, an infrared touch screen panel includes: a planar touch input region configured to receive a touch input; a plurality of infrared ray emitters located at a first side and a second side of the planar touch input region and configured to emit a plurality of infrared rays toward a third side and a fourth side, respectively, of the planar touch input region, that are opposite the first side and the second side, respectively; and a plurality of infrared ray sensors located at the third side and the fourth side of the planar touch input region and configured to sense the infrared rays supplied from the infrared ray emitters at the first side and the second side; wherein each of the infrared ray emitters includes: a light guide plate having a main surface on a side facing a corresponding infrared ray sensor of the infrared ray sensors as a light emitting surface, a main surface on another side having a plurality of V-shaped oblique grooves at a first angle and facing the light emitting surface, and at least one section as a light incident surface; an infrared ray light source located at a side facing toward the at least one light incident surface of the light guide plate; and a reverse prism seat located between the planar touch input region and the light guide plate and having a main surface at a side facing toward the light guide plate as a light incident surface and a plurality of polygonal reverse prism threads formed on the light incident surface of the reverse prism seat.

Each of the infrared ray emitters may be configured to emit infrared rays in a direction perpendicular to the light emitting surface of the corresponding light guide plate and the corresponding reverse prism seat.

The first angle may be a vertex angle, located at a side where light enters, among vertex angles of a triangle formed by a section of the V-shaped grooves that are formed on the light guide plate of each of the infrared ray emitters, and is set from 1° to 3°.

A vertex angle among a plurality of vertex angles formed by sections of the V-shaped grooves that are formed on the light guide plate of each of the infrared ray emitters may have an angle from 130° to 150°.

The first side and the second side may be adjacent to each other.

The infrared ray emitters and the infrared ray sensors may be located on an outer upper surface of the planar touch input region, the infrared ray emitters being configured to emit the infrared rays toward the infrared ray sensors in a direction parallel to the planar touch input region on a substrate forming the planar touch input region.

The infrared ray emitters and the infrared ray sensors may be located at edges of a substrate forming the planar touch input region, the infrared ray emitters being configured to emit the infrared rays to enter the substrate at an angle, such that the infrared rays may be reflected in the substrate and may enter the infrared ray sensors.

The infrared ray emitters may be obliquely mounted against a surface perpendicular to and in the same plane as the planar touch input region of the substrate such that the infrared rays may be supplied at the angle.

According to embodiments of the present invention, an infrared touch screen panel may be thin and have excellent emission property.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view schematically illustrating a structure of a touch screen panel according to one embodiment of the present invention;

FIG. 2 is a sectional view schematically illustrating the touch screen panel of the embodiment of FIG. 1;

FIG. 3 is a sectional view illustrating an operating principle of the touch screen panel of the embodiment of FIG. 1 and FIG. 2;

FIG. 4 is an exploded perspective view illustrating an example of an infrared ray emitter of the embodiment of FIG. 1;

FIG. 5 is a sectional view illustrating an operation of the infrared ray emitter of the embodiment of FIG. 1 and FIG. 4; and

FIG. 6A and FIG. 6B are sectional views schematically illustrating a structure and an operating principle of a touch screen panel according to additional embodiments of the present invention.

### DETAILED DESCRIPTION

In the following detailed description, only certain exemplary embodiments of the present invention have been shown and described, by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or can be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, various embodiments by which those skilled in the art may easily perform the present invention will be described in detail with reference to the accompanying drawings.

Generally, in an infrared touch screen panel, infrared rays are emitted from sides of X-axis and Y-axis, and opposite sides receive the emitted infrared rays so that grids are formed.

Generally, when a touch input is provided to the infrared touch screen panel, infrared rays emitted in the transversal direction and longitudinal direction of a portion to which the touch input is provided are blocked. Therefore, when X- and Y-coordinates of the region where the infrared rays are blocked are obtained, the position to which the touch input is provided may be detected.

In order to improve the detecting property of the infrared touch screen panel, the infrared rays may be arranged uniformly from a light source along the X-axis and the Y-axis to be emitted so that an emission property of the infrared ray may be improved.

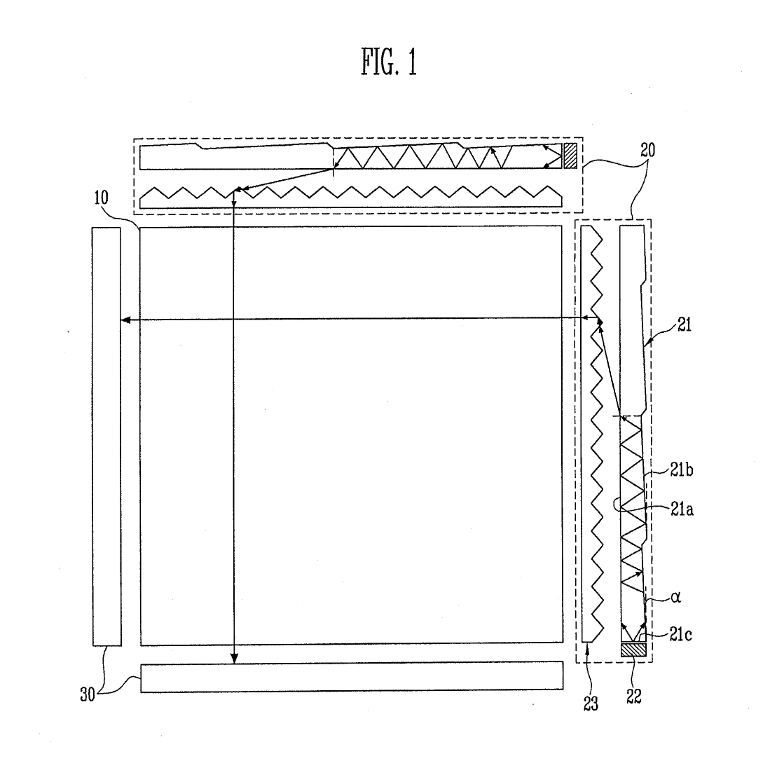

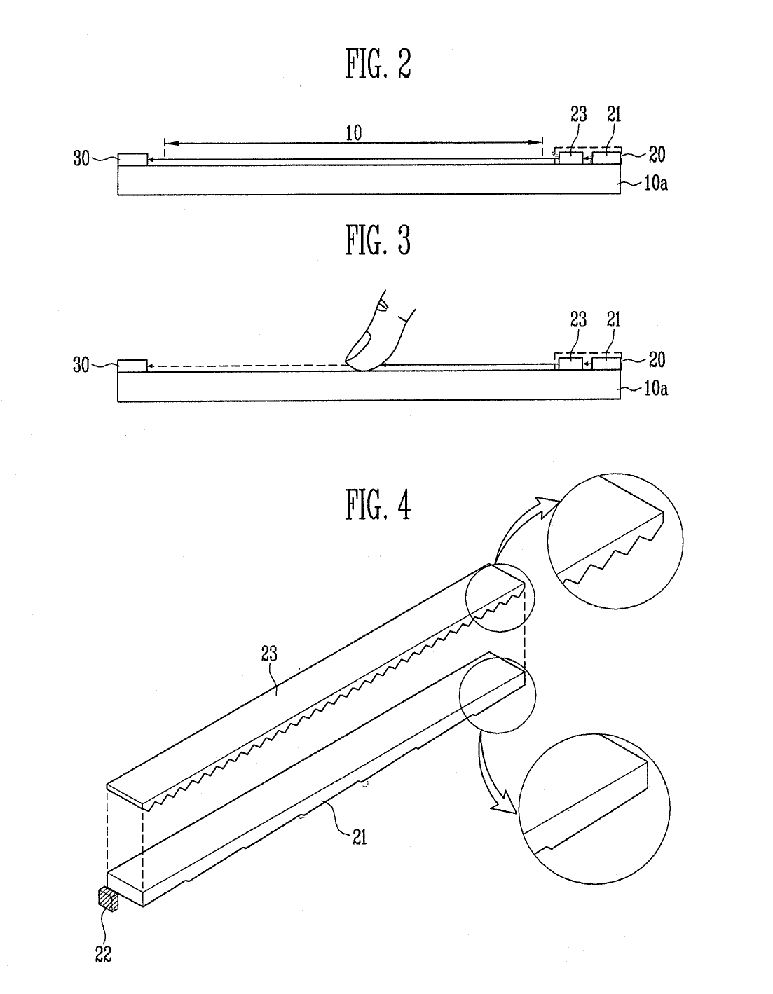

FIG. 1 is a plan view schematically illustrating a structure of a touch screen panel according to one embodiment of the present invention. FIG. 2 is a sectional view schematically illustrating the touch screen panel of the embodiment of FIG. 1. FIG. 3 is a sectional view illustrating an operating principle of the touch screen panel of the embodiment of FIG. 1 and FIG. 2.

Referring to FIG. 1, a touch screen panel according to one embodiment of the present invention includes a planar touch input region 10 for receiving a touch input, infrared ray emitters 20 arranged at a first side and a second side of the touch input region 10 and for emitting infrared rays toward a third side and fourth side that are opposite to the first side and the second side, respectively, and infrared ray sensors 30 arranged at the third side and the fourth side of the touch input region 10 and for sensing the infrared rays supplied from the infrared ray emitters 20 at the first side and the second side, respectively.

The touch input region 10 is formed on the front side of a substrate forming the touch screen panel, and may be defined on an additional substrate for a touch screen panel for the touch input or on the front side of a display panel without the additional substrate. For example, in one embodiment of the present invention, the touch input region 10 is formed on the front side of an image displaying surface of the display panel.

The infrared ray emitters 20 emit infrared rays from respective sides of X-axis and Y-axis to form infrared ray grids on the touch input region 10.

To this end, the infrared ray emitters 20 are arranged adjacent to the first side and the second side of the touch input region 10 and emit infrared rays toward the third side and the fourth side, respectively, opposite to the first side and the second side, respectively.

In one embodiment of the present invention, the first side and the second side are adjacent to each other. For example, when the touch input region 10 is rectangular, the infrared ray emitters 20 may be formed at two perpendicular sides of the touch input region 10.

Each of the infrared ray emitter 20 includes a light guide plate 21 for an emitting infrared ray from an infrared ray light source 22 in a direction perpendicular to a light emitting surface 21a, an infrared ray light source disposed at a light incident surface 21c of the light guide plate 21, and a reverse prism seat 23 disposed between the light guide plate 21 and the touch input region 10.

In particular, according to one embodiment of the present invention, the light guide plate 21 is characterized by taking a main surface of a side facing the touch input region 10 as a light emitting surface 21a, taking a main surface of another side facing the light emitting surface 21a as a light reflecting surface 21b, taking at least one section of the infrared ray light source 22 as a light incident surface 21c, and forming a plurality of V-shaped oblique grooves having a first angle α.

The reverse prism seat 23 takes a main surface of the light guide plate 21 as a light incident surface and has a polygonal reverse prism threads formed on the light incident surface.

Due to this structure, the infrared ray emitters 20 emit infrared rays in the direction crossing the light emitting surfaces of the light guide plates 21 and the reverse prism seats 23 and form infrared ray grids in the touch input region 10.

According to one embodiment of the present invention, the infrared ray emitters 20 and the infrared ray sensors 30 may be positioned on the outside of the touch input region 10. For example, the infrared ray emitters 20 and the infrared ray sensors 30, as illustrated in FIG. 2, may be positioned outside the upper surface of a substrate 10a (substrate for a touch screen pan& or substrate on a display panel side) forming the touch input region 10.

In this case, the infrared rays emitted from the infrared ray emitters 20 advance from the upper side of the substrate 10a forming the touch input region 10 to the infrared ray sensors 30 along a direction parallel to the touch input region 10.

When a touch input is provided to the infrared touch screen panel, as illustrated in FIG. 3, the infrared rays are blocked by a portion to which the touch input is provided, and therefore the position to which the touch input is provided may be sensed when X- and Y-coordinates of the region where the infrared rays are blocked.

According to one embodiment of the present invention as described above, when the infrared ray emitters 20 are constructed such that the light reflecting surfaces 21b include the light guide plates 21 formed with the plurality of V-shaped grooves and the reverse prism seats 23, the infrared rays are rotated by 90° and emitted from the infrared ray light sources 22 at high efficiency. By doing so, an infrared touch screen panel having light emission property may be provided.

In addition, although FIG. 1 slightly exaggerates the sizes of the infrared ray emitters 20 and the infrared ray sensors 30, the infrared ray emitters 20 and the infrared ray sensors 30 actually have thin thicknesses. For example, sum of the light guide plates 21 and the reverse prism seats 23 that are provided in the infrared ray emitters 20 may together have a thickness less than 1 mm. That is, driving devices for implementing the infrared touch screen panel may be thin.

In contrast to a resistive touch screen panel and a capacitive touch screen panel, an infrared touch screen panel generally does not include additional electrodes formed in the touch input region 10. Therefore, the infrared ray emitters 20 and the infrared ray sensors 30 are mounted outside the substrate of a display panel side without an additional substrate for a touch screen panel so that an infrared touch screen panel may be implemented.

That is, the infrared touch screen panel according to embodiments of the present invention is implemented thin and has an excellent light-emission property.

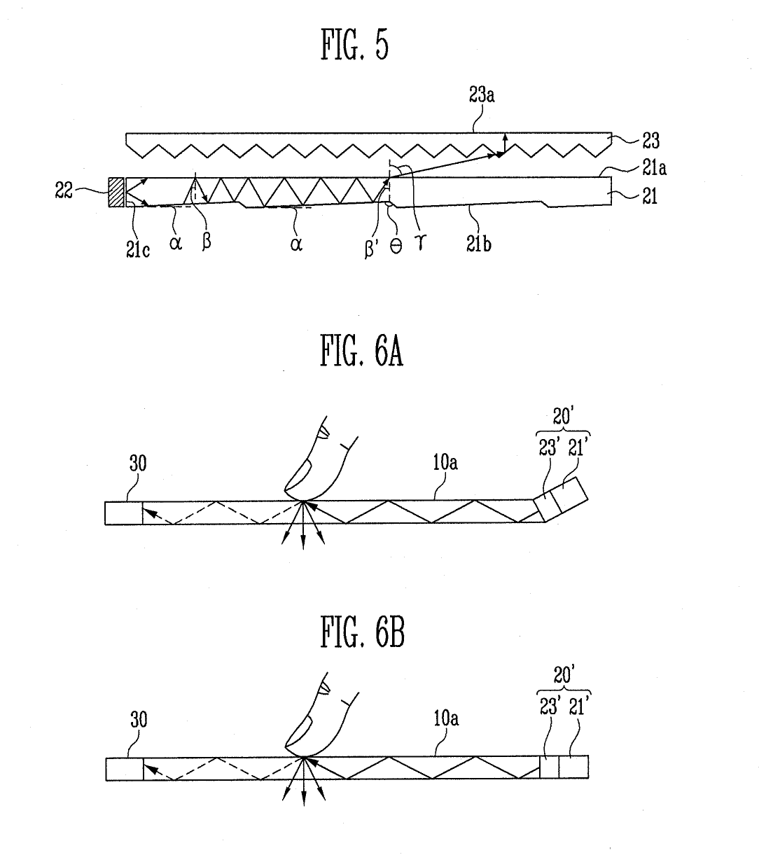

FIG. 4 is an exploded perspective view illustrating an example of an infrared ray emitter of FIG. 1. FIG. 5 is a sectional view illustrating an operation of the infrared ray emitter of FIG. 1 and FIG. 4.

Hereinafter, principle that the touch screen panel according to embodiments of the present invention provides an excellent light-emission property will be described with reference to FIG. 4 and FIG. 5 in detail.

Referring to FIG. 4 and FIG. 5, the light reflecting surfaces 21b of the light guide plates 22 have a plurality of V-shaped oblique grooves at a first angle α. At this time, there is no limit to depth, width, and pitch of the V-shaped grooves.

According to one embodiment of the present invention, the first angle α is an incident angle, and more specifically a vertex angle of a side which light enters, among vertex angles of a triangle formed by a section of the V-shaped grooves of the light guide plates 21. The first angle α may be designed to be within a range from 1° to 3°. This is to allow the infrared rays emitted via the light guide plates 21 and the reverse prism seats 23 to be emitted in a direction perpendicular to the light emitting surfaces 21a and 23a of the light guide plates 21 and the reverse prism seats 23, and may be modified according to a designed structure of the reverse prism seats 23.

In addition, a vertex angle θ formed by both slopes, among the vertex angles of the triangle forming the V-shaped grooves on the light guide plates 21, may be designed to be within a range from 130° to 150°. However, the vertex angle θ may be modified by the designed structure of the reverse prism seats 23 like the first angle α.

If the infrared rays enter the light incident surfaces 21c of the light guide plates 21 from the infrared ray light source 22, when the incident infrared rays have an angle greater than a critical angle while being totally reflected and advancing in the light guide plates 21, the infrared rays are emitted through the light emitting surfaces 21a.

According to one embodiment of the present invention, in order to have an outer refraction angle from 0° to 2° using the reverse prism seats 23 (e.g., in order to emit the infrared rays in a direction approximately perpendicular to the light emitting surfaces 21a and 23a of the light guide plates 21 and the reverse prism seats 23), a refraction angle γ of the light emitting surfaces 21a of the light guide plates 21 must be controlled to a range (e.g., a predetermined range from 74° to 76°) and the refraction angle γ of the light emitting surfaces 21a is determined by an incident angle β.

According to one embodiment of the present invention, because on the light reflecting surfaces 21b of the light guide plates 21 of one embodiment, a vertex angle among the vertex angles of a triangle formed by the section formed by both slopes, is designed to have an angle from 130° to 150° and a vertex angle α near the infrared ray light sources 22 has a plurality of V-shaped grooves with an angle in the range 1° to 3°, when the infrared rays entering the light guide plates 21 are reflected an Nth time by the light reflecting surfaces 21b of the light guide plates 21, the incident angle β′ of the light emitting surfaces 21a is increased to β+N*α.

According to one embodiment of the present invention, the incident angle is increased by α whenever (or each time) the infrared rays are reflected once by the light reflecting surfaces 21b of the light guide plates 21. When the increased incident angle is greater than the critical angle, the infrared rays are emitted through the light emitting surfaces 21a of the light guide plates 21 at a reflection angle γ (e.g., a specific refraction angle γ).

The infrared rays emitted from the light guide plates 21 are radiated in the direction substantially perpendicular to the light emitting surfaces 23a of the reverse prism seats 23 via the reverse prism seats 23.

That is, the infrared ray emitters 20 including the light guide plates 21 and the reverse prism seats 23 according to embodiments of the present invention refract and emit the infrared rays from the infrared ray light source 22 at high efficiency, so that the light emission property of the infrared touch screen panel may be improved.

FIG. 6A and FIG. 6B are sectional views schematically illustrating a structure and an operating principle of a touch screen panel according to one embodiment of the present invention. With respect to FIG. 6A and FIG. 6B, description of elements similar or identical to those of the previously-described embodiments will be omitted.

Referring to FIG. 6A and FIG. 6B, infrared ray emitters 20′ and infrared ray sensors 30 are positioned at both sides of a substrate 10a forming the touch input region. That is, in this embodiment, the infrared ray emitters 20′ and the infrared ray sensors 30 are not mounted on the substrate 10a but on the edges (or sides) (e.g., on a plane, as illustrated in FIG. 1, the infrared ray emitters 20′ and the infrared ray sensors 30 are mounted in X-axis direction and in Y-axis direction respectively).

FIG. 6A shows an example in which the infrared ray emitters 20′ are substantially the same as those of the previously described embodiments such that infrared rays are emitted in the direction perpendicular to the light emitting surfaces of the light guide plates 21′ and the reverse prism seats 23′ and in which the infrared emitters 20′ are obliquely mounted at an angle such that the infrared rays entering the substrate 10a enter by an angle of being totally reflected in the substrate 10a.

The infrared ray emitters 20′ are substantially similar to those of the previous embodiment and may be obliquely mounted against a surface perpendicular to (and in the same plane as) the touch input region of the substrate 10a at an angle (e.g., a predetermined angle), so that the infrared rays emitted from the infrared ray emitters 20′ enter the substrate 10a at an angle in a range where the infrared rays may be totally reflected. To this end, stepped structures may be disposed under the infrared ray emitters 20′.

In addition, as illustrated in FIG. 6B, the infrared ray emitters 20′ may be disposed parallel to (e.g., in the same plane as) the substrate 10a. In this case, the infrared rays emitted from the infrared ray emitters 20′ are controlled to enter a side of the substrate 10a at an angle in a range where the infrared rays are totally reflected in the substrate 10a by controlling the angle of the V-shaped grooves of the light guide plates 21′ and/or the angle of threads of the reverse prisms formed in the reverse prism seats 23′.

That is, the incident angle of the infrared rays entering the substrate 10a is designed to have an angle where the infrared rays may be totally reflected in the substrate 10a.

Therefore, according to one embodiment of the present invention, the infrared rays emitted from the infrared ray emitters 20′ are totally reflected in the substrate 10a and enter the infrared ray sensors 30 positioned at another side of the substrate 10a.

When a touch input is provided to the touch screen panel, the total reflection condition is broken in a region where the touch input is provided. That is, when a touch input is provided, frustrated total internal reflection (FTIR) occurs and the infrared rays are absorbed or scattered into near material while passing through an interface of medium so that the infrared rays advancing to the infrared ray sensors 30 are dampened or blocked. Therefore, when X- and Y-coordinates of a region where the infrared ray are dampened or blocked are obtained, the position at which the touch input is provided may be sensed.

When the infrared ray emitters 20′ including the light guide plates 21′ having the V-shaped grooves formed on the light reflecting surfaces and the reverse prism seats 23′ are located even with (or in the same plane as) the touch screen panel according to this embodiment, infrared rays may be supplied into the substrate 10a at a stable angle and at high efficiency. Therefore, a touch screen panel with improved light emission property may be provided.

In addition, an infrared touch screen panel using thin driving devices without an additional substrate of a touch screen panel for the touch input region 10 may be achieved and since the infrared ray emitters 20′ and the infrared ray sensors 30 are positioned at sides of the substrate 10a, a thin touch screen panel may be provided.

The present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a planar touch input region configured to receive a touch input;
a plurality of infrared ray emitters located at a first side and a second side of the planar touch input region and configured to emit a plurality of infrared rays toward a third side and a fourth side, respectively, of the planar touch input region, that are opposite the first side and the second side, respectively; and
a plurality of infrared ray sensors located at the third side and the fourth side of the planar touch input region and configured to sense the infrared rays supplied from the infrared ray emitters at the first side and the second side;
wherein each of the infrared ray emitters comprises:
a light guide plate having a main surface on a side facing a corresponding infrared ray sensor of the infrared ray sensors as a light emitting surface, a main surface on another side having a plurality of V-shaped oblique grooves at a first angle and facing the light emitting surface, and at least one section as a light incident surface;
an infrared ray light source located at a side facing toward the at least one light incident surface of the light guide plate; and
a reverse prism seat located between the planar touch input region and the light guide plate and having a main surface at a side facing toward the light guide plate as a light incident surface and a plurality of polygonal reverse prism threads formed on the light incident surface of the reverse prism seat.

2. The touch screen panel as claimed in claim 1, wherein each of the infrared ray emitters is configured to emit infrared rays in a direction perpendicular to the light emitting surface of the corresponding light guide plate and the corresponding reverse prism seat.

3. The touch screen panel as claimed in claim 1, wherein the first angle is a vertex angle, located at a side where light enters, among vertex angles of a triangle formed by a section of the V-shaped grooves that are formed on the light guide plate of each of the infrared ray emitters, and is set from 1° to 3°.

4. The touch screen panel as claimed in claim 1, wherein a vertex angle among a plurality of vertex angles formed by sections of the V-shaped grooves that are formed on the light guide plate of each of the infrared ray emitters has an angle from 130° to 150°.

5. The touch screen panel as claimed in claim 1, wherein the first side and the second side are adjacent to each other.

6. The touch screen panel as claimed in claim 1, wherein the infrared ray emitters and the infrared ray sensors are located on an outer upper surface of the planar touch input region, the infrared ray emitters being configured to emit the infrared rays toward the infrared ray sensors in a direction parallel to the planar touch input region on a substrate forming the planar touch input region.

7. The touch screen panel as claimed in claim 1, wherein the infrared ray emitters and the infrared ray sensors are located at edges of a substrate forming the planar touch input region, the infrared ray emitters being configured to emit the infrared rays to enter the substrate at an angle, such that the infrared rays are reflected in the substrate and enter the infrared ray sensors.

8. The touch screen panel as claimed in claim 7, wherein the infrared ray emitters are obliquely mounted against a surface perpendicular to and in a same plane as the planar touch input region of the substrate such that the infrared rays may be supplied by at the angle.
